(19) United States
(12) Patent Application Publication
(10) Pub. No.: US 2006/0062892 A1
(43) Pub. Date: Mar. 23, 2006

(54) Dry pet food with kibble, dried vegetables and dried meat jerky pieces

(76) Inventor: Tyler W. Merrick, Amarillo, TX (US)

Correspondence Address: LOCKE LIDDELL & SAPP LLP;ATTN: SUE COTT, 2200 ROSS AVENUE, SUITE 2200, DALLAS, TX, 75201-6776, US

(21) Appl. No.: 10/944,397

(22) Filed: Sep. 17, 2004

(51) Int. Cl. A23K 1/00

(52) U.S. Cl. 426/635

(57) ABSTRACT

A premium, all natural pet food comprising a dry kibble coated with a dried natural gravy and mixed with a plurality of pieces of at least one of a dried vegetable or fruit, and with a plurality of pieces of dried meat jerky.

### BACKGROUND OF THE INVENTION

1. Field of the Invention

This invention relates to pet food and, more particularly, to a dry pet food comprising kibble in combination with freeze-dried or dehydrated vegetables and/or fruit, and dried meat jerky pieces. Most preferably, the kibble also comprises animal proteins and is coated with a dried natural gravy coating.

2. Description of Related Art

Dry pet food comprising kibble coated with a dry natural gravy coating that reconstitutes when mixed with water is well known. Canned dog food containing meat chunks and vegetables is also well known. More recently, dry pet foods have been introduced that comprise freeze-dried vegetables. U.S. Pat. No. 5,673,653 discloses an animal treat comprising jerky wrapped in a rawhide sheet. A dry pet food is needed that supplements kibble with the nutritional benefits and taste enhancements attainable from vegetables and dried meat jerky, particularly in a form optionally including a natural gravy.

### SUMMARY OF THE INVENTION

Notwithstanding the pet foods and treats previously known, I have discovered that many beneficial results are achievable with a new dry pet food comprising a mixture of kibble, preferably coated with dehydrated natural gravy; freeze-dried or dehydrated vegetables; and dried meat jerky pieces. A dried fruit component is optionally included, either together with, or substituted for, the dried vegetable component of the subject pet food. Meats suitable for use in making the jerky component of the invention comprise beef, pork, chicken, turkey, duck, buffalo, venison and fish.

The pet foods of the invention can be effectively tailored for use with puppies, mature dogs or aging dogs, and also represent a good way to administer medications by mixing and disguising them in the food. With the preferred pet food of the invention, which also desirably comprises a dehydrated natural gravy component, the pet owner can conveniently elect at each feeding whether to serve the food wet or dry. Even when the food is served dry, the natural saliva of the pet will make the food more flavorful, even without creating the “fully gravy” experience.

### DESCRIPTION OF THE PREFERRED EMBODIMENTS

A preferred pet food of the invention is made by combining a conventional kibble with pieces of dried vegetables and dried meat jerky. The kibble preferred for use in making the subject dry pet food desirably comprises components selected from grains such as rice, barley and oatmeal; animal protein; animal fats such as chicken fat, beef fat, and the like; vegetable oils such as canola oil, flaxseed oil, olive oil, sunflower oil, or similar natured vegetable oils; added vitamins and minerals; herbs and seasonings such as garlic, rosemary, salt, thyme; and animal proteins such as chicken, chicken liver, beef, beef liver, turkey, duck, buffalo, venison, lamb, pork, beef tripe, pheasant, Cornish game hens, trout, salmon, crab, lobster, crawfish, ocean white fish, tuna, shrimp, walleye; and various other seafood and animal proteins. The kibble component of the invention can be made by any conventional means known to those of ordinary skill in the art. The kibble is preferably made by grinding, chopping or dicing the raw ingredients to a preferred particle size, which may vary by ingredient; combining and mixing the ingredients, and optionally heating them for a time and at a temperature sufficient to cook any raw meat ingredients. The resultant mass is then extruded into a pelletized product that is dried to produce the finished kibble. It should be appreciated, however, upon reading this disclosure, that the pet food of the invention can also comprise a kibble component that contains other ingredients made according to other processes, provided that the resultant product is generically classifiable as a “kibble” by those of ordinary skill in the art.

According to a particularly preferred embodiment of the invention, the kibble is coated with a natural gravy material that is dry when the kibble is packaged, but hydrates to produce a tasty gravy when the kibble is mixed with warm or cold water prior to serving. Materials suitable for use in the gravy coating can include, for example, finely divided particles of dried chicken or beef stock; finely divided particles of dried chicken, dried beef, dried venison, dried lamb, dried turkey or dried fish; natural flavors such as garlic, celery or the like; and natural colorants. The natural gravy coating is desirably added after the kibble product is dried. Initially, sufficient liquid animal fat protein or a vegetable-based fat is applied to the kibble to wet the outer surface. Immediately afterward, the powdered natural gravy product and powdered protein such as dried chicken liver or beef liver is sprinkled into a mixing chamber and mixed together with the kibble to achieve a consistent, evenly distributed coating that sticks to the outside of the kibble. The coating desirably comprises from about 1 to about 1.5 percent, by weight of the finished pet food. The moisture content of the coated kibble preferably ranges from about 9 to about 11 percent by weight of the kibble.

The preferred pet food of the invention desirably further comprises from about 2 to about 3 weight percent, and most preferably, from about 2 to about 2.5 weight percent dried vegetables, by weight of the finished pet food. Examples of vegetables that can be incorporated into the subject pet food include, without limitation, potatoes, sweet potatoes, peas, carrots, zucchini, squash, beans, green beans, corn, hominy, tomatoes, spinach and mixtures thereof. According to a particularly preferred embodiment of the invention, the vegetables are chopped, cooked and freeze-dried prior to combining them with the kibble. If needed in order to reduce costs, dehydrated vegetable pieces can be substituted for all or a portion of the freeze-dried vegetables. Also, depending upon factors such as the cost and availability of dried fruit relative to dried vegetables, one or more freeze-dried or dehydrated fruit components can likewise be added to the dry pet food of the invention either in combination with, or in substitution for, vegetable pieces. Examples of fruits that might be included in the subject pet food include apple varieties such as Fuji, golden delicious, red delicious and granny smith, and various other fruits such as cranberries, blueberries, peaches, cantaloupe, pears, apricots, blackberries, papaya, strawberries, raspberries and mangos. The size of the dried vegetable, and optionally fruit, pieces preferably ranges from about ⅛ inch to about ½ inch cubes. The moisture content of the dried vegetable, and optionally fruit, pieces preferably ranges from about 2 to about 4 percent. Such pieces are desirably large enough and of such configuration that they remain distributed throughout the kibble during shipment and storage. The dried vegetable and/or fruit ingredients are preferably metered into the flow of kibble just prior to packaging to achieve the desired compositional percentages, distribution, and consistency in the end product.

The preferred pet food of the invention desirably further comprises from about 0.25 to about 2.0 weight percent, and most preferably from about 0.75 to about 1.5 weight percent, dried meat jerky pieces, by weight of the finished pet food. While it is understood that more dried meat jerky can be used, the presence of from about 0.75 to about 1.5 weight percent dry meat jerky, when hydrated, is sufficient to make the meat pieces plainly visible and nutritionally effective in the resultant pet food. Examples of meat products that can be incorporated into the subject pet food include, without limitation, beef, pork, chicken, turkey, duck, turducken, buffalo, venison, lamb, pheasant, rabbit, veal, trout, salmon, ocean white fish tuna, crab, lobster, crawfish and various other seafoods. According to a particularly preferred embodiment of the invention, the meat jerky is made from a meat slurry comprising a desired animal protein source or mixture of various sources, which is forced into a plastic casing and cooked to a core temperature of about 185° F. for about two hours and then cooled and chilled to a consistency of bologna. The plastic casing is then removed and individual chubs are passed through a dicer that can produce individual diced cubes ranging in size from about ⅛ to about ½ inch. The cubes are then placed in a drier that dries the product for about 9 to 13 hours at a temperature ranging from about 160 to 180° F., which reduces the moisture content to a level ranging from about 2 to about 5 weight percent, yielding dried pieces of the subject meat jerky. The dried jerky pieces are desirably large enough and of such configuration that they remain distributed throughout the kibble during shipment and storage.

The dry pet food of the invention is most preferably a dog food, and can be conveniently packaged in conventional 5, 15 and 30 pound bags, although other sized bags, boxes or other similarly effective packages can also be used. The dry pet food is preferably served by mixing it with water in a ratio of about ½ cup of water to about 1 cup of dry pet food and allowing to sit from about 30 seconds to 1 minute prior to serving to allow the natural gravy, dried vegetables and dried meat jerky to re-hydrate at least partially, while maintaining some crunchiness to the kibble. The kibble may sit longer in the gravy prior to serving in order to make the kibble softer for puppies or senior pets that have a harder time chewing. The resultant dish of pet food has the apparent consistency of a stew, with the vegetable (fruit) and meat jerky pieces being plainly visible. The fully wetted product is generally easier for puppies to consume and is often more attractive to older dogs, especially senior dogs that may have difficulty chewing. Medicinal products for dogs, whether liquid or solid, are generally easier to disguise when mixed into a bowl of the food containing the gravy and having a stew-like consistency. This procedure should not, however, be followed with medicines prescribed for oral administration apart from meals.

Still, some pet owners do not like adding water to dry dog foods and prefer a crunchier kibble, although the core of the kibble typically still stays crunchy even with water. Even dry, the pet food disclosed herein is tasteful and nutritious because the dog's saliva wets the natural gravy coating, vegetable pieces and dried meat pieces to a more limited extent, but these elements still provide flavor and variety in the diet of any dog. The dry kibble product of the invention can also help keep a dog's teeth clean by controlling some of the natural tartar build-up as a result of friction between the kibble and the teeth during eating.

The pet food of the invention is further described and explained in relation to the following examples:

### EXAMPLE 1

A chicken-based dry kibble is made by mixing chicken meat, mixed grains, chicken fat, flax seed oil, vitamins and minerals required by the American Association of Feed Control Officials (“AFFCO”), chicory root, marigold extract, whole cleave garlic, probiotics, prebiotics, potassium chloride, lysine, choline chloride, yucca shidegra extract, chondroitin sulfate and glucosamine hydrochloride, which is then extruded and dried to a moisture content of about 10 weight percent. The kibble is then coated with chicken fat again and coated with dried chicken liver, chicken-based gravy mix including dried chicken stock, dried chicken, garlic flavor, celery flavor, natural colors and natural flavors, and allowed to dry. The dry kibble is then combined with dried vegetable pieces and dried chicken meat pieces prepared in accordance with the jerky preparation method disclosed above. The vegetable pieces comprise about 2 weight percent based on the finished food and include a mixture of white potatoes, peas carrots and sweet potato pieces, the pieces having an average size of about ⅛ in cube to ½ in cube, and a moisture content of about 10 weight percent. The dried chicken meat pieces comprise about 0.75 weight percent based on the finished pet food, have an average size of about ⅛ in cube to ½ in cube, and an average moisture content of about 2 to 5 weight percent. The resultant chicken-based dry pet food containing gravy-coated kibble, dried vegetables and dried meat jerky is then packaged in conventional bags.

### EXAMPLE 2

A beef-based dry pet food is made as described in Example 1, except that beef, beef fat, beef liver, beef-based gravy mix and dried beef pieces are substituted for chicken, chicken fat, chicken liver, chicken-based gravy mix and dried chicken pieces, and the dried beef pieces comprise about 1.5 weight percent based on the finished pet food.

### EXAMPLE 3

A turducken-based dry kibble is made by mixing turkey meat, chicken meat and duck meat with various grains, along with chicken fat and flax seed oil, added vitamins and minerals required by AAFCO, chicory root, marigold extract, garlic, chicory root, probiotics, prebiotics, potassium chloride, lysine, choline chloride, yucca shidegra extract, chondroitin sulfate and glucosamine hydrochloride, apples and blueberries. The mixed ingredients are extruded, dried to a moisture content of about 10 weight percent, and then coated with Chicken Fat, dried chicken liver particles, and a chicken-based gravy mix as described in Example 1 above. The dry kibble is then combined with dried vegetable pieces and dried turducken meat pieces. The vegetable pieces comprise about 2.25% weight percent by weight of the finished pet food and have a moisture content not exceeding about 10 weight percent. The dried turducken meat pieces made of turkey, duck and chicken comprise about 0.75% weight percent based on the finished pet food, have an average size of about ⅛ in cube to ½ in cube, and an average moisture content of about 2 to 5 weight percent. The resultant turducken-based dry pet food containing gravy-coated kibble, dried vegetables and dried meat jerky is then packaged in conventional bags.

### EXAMPLE 4

A wilderness blend of dry kibble is made by mixing buffalo meat, venison meat and salmon meal along, with rice, barley and oatmeal, along with canola oil and flax seed oil, added vitamins and minerals required by AAFCO, chicory root, marigold extract, garlic, probiotics, prebiotics, potassium chloride, lysine, choline chloride, yucca shidegra extract, chondroitin sulfate and glucosamine hydrochloride, apples and blueberries, and these formulas are made in accordance with AAFCO standards. The mixture is heated as needed to cook any raw meat in the mixture, and then extruded and dried to a moisture content of about 10 weight percent. The dried kibble is coated with canola oil again, and then with dried chicken liver, venison-based gravy mix including dried venison stock, dried venison, garlic flavor, celery flavor, and natural flavors and colors. The dry kibble is then combined with dried vegetable pieces and dried chicken meat pieces. The vegetable pieces comprise about 2.5 weight percent of the finished pet food and include but are not limited to white potatoes, peas, carrots and sweet potato pieces having an average size of about ⅛″ cube to ½ inch cube, and a moisture content of about 10 weight percent. The wilderness blend meat pieces made up of buffalo, venison and salmon meal comprise about 1 weight percent of the finished pet food, have an average size of about ⅛ inch cube to ½ inch cube, and an average moisture content of about 2 to 5 weight percent. The resultant wilderness blend dry pet food containing gravy-coated kibble, dried vegetables and dried meat jerky is then packaged in conventional bags.

### EXAMPLE 5

A turducken-based dry kibble for puppies is made as described in Example 3, except that higher amounts of protein and fat are incorporated into the basic kibble because of their nutritional needs.

### EXAMPLE 6

A chicken-based dry kibble for senior pets is made as described in Example 1, except that lower amounts of protein and fat are incorporated into the basic kibble because of their nutritional needs.

### EXAMPLE 7

A chicken-based dry pet food is made as in Example 1 except that pieces of dried fruit such as dried apples, blueberries, cranberries, peaches, cantaloupe, pears, apricots, blackberries, papaya, strawberries, raspberries and mangos, or mixtures thereof, are substituted for a portion of the dried vegetable pieces, and both the vegetable pieces and the fruit pieces are freeze-dried.

### EXAMPLE 8

A beef-based dry pet food is made as in Example 2 except that pieces of dried fruit such as apples, blueberries, cranberries, peaches, cantaloupe, pears, apricots, blackberries, papaya, strawberries, raspberries and mangos peaches, pears, mangos, or mixtures thereof, are substituted for all of the dried vegetable pieces.

Other alterations and modifications of the invention will likewise become apparent to those of ordinary skill in the art upon reading this specification in view of the accompanying drawings, and it is intended that the scope of the invention disclosed herein be limited only by the broadest interpretation of the appended claims to which the inventor is legally entitled.

I claim:

1. A pet food comprising a dry kibble mixed with a plurality of pieces of dried meat jerky and a plurality of pieces of at least one of a dried vegetable or fruit.

2. The pet food of claim 1 wherein the kibble is coated with a dried natural gravy.

3. The pet food of claim 1 comprising a plurality of pieces of at least one dried vegetable.

4. The pet food of claim 3 wherein the dried vegetable is dehydrated.

5. The pet food of claim 3 wherein the dried vegetable is freeze-dried.

6. The pet food of claim 3 comprising a plurality of pieces of at least one dried fruit.

7. The pet food of claim 6 wherein the dried fruit is dehydrated.

8. The pet food of claim 6 wherein the dried fruit is freeze-dried.

9. The pet food of claim 1 comprising a plurality of pieces of at least one dried vegetable and at least one dried fruit.

10. The pet food of claim 9 wherein at least part of the dried vegetable is freeze-dried.

11. The pet food of claim 9 wherein at least part of the dried fruit is freeze-dried.

12. The pet food of claim 1 wherein the dried meat jerky comprises meat selected from the group consisting of beef, pork, chicken, turkey, duck, turducken, buffalo, venison, lamb, pheasant, rabbit, veal, trout, salmon, ocean white fish, tuna, crab, lobster, crawfish, and mixtures thereof.

13. The pet food of claim 12 wherein the meat is beef.

14. The pet food of claim 12 wherein the meat is pork.

15. The pet food of claim 12 wherein the meat is chicken.

16. The pet food of claim 12 wherein the meat is turkey.

17. The pet food of claim 12 wherein the meat is duck.

18. The pet food of claim 12 wherein the meat is turducken.

19. The pet food of claim 12 wherein the meat is buffalo.

20. The pet food of claim 12 wherein the meat is venison.

21. The pet food of claim 12 wherein the meat is fish.

22. The pet food of claim 12 wherein the fish is seafood other than fish.

23. The pet food of claim 1 wherein the kibble further comprises protein derived from at least one animal, fowl, fish or seafood other than fish.

24. The pet food of claim 1 wherein the dried vegetable is selected from the group consisting of potatoes, sweet potatoes, peas, carrots, zucchini, squash, beans, green beans, corn, hominy, tomatoes, spinach and mixtures thereof.

25. The pet food of claim 1 wherein the dried fruit is selected from the group consisting of apples, blueberries, cranberries, peaches, cantaloupe, pears, apricots, blackberries, papaya, strawberries, raspberries and mangos, and mixtures thereof.

26. A puppy food having the composition of the pet food of claim 1.

27. An adult dog food having the composition of the pet food of claim 1.

28. A senior dog food having the composition of the pet food of claim 1.

29. A cat food having the composition of the pet food of claim 1.

30. The pet food of claim 1 wherein the dried vegetable pieces are cubes ranging in size from about ⅛ inch to about ½ inch.

31. The pet food of claim 1 comprising from about 2 to about 2.5 weight percent dried vegetable pieces, by weight of the pet food.

32. The pet food of claim 1 wherein the dried fruit pieces are cubes ranging in size from about ⅛ inch to about ½ inch.

33. The pet food of claim 1 comprising from about 0.25 to about 0.75 weight percent dried fruit pieces.

34. The pet food of claim 1 wherein the dried meat jerky pieces are cubes ranging in size from about ⅛ inch to about ½ inch.

35. The pet food of claim 1 comprising from about 0.25 to about 2.0 weight percent dried meat jerky.

36. The pet food of claim 35 comprising from about 0.75 to about 1.5 weight percent dried meat jerky.

37. The pet food of claim 12 wherein the meat is lamb.

38. The pet food of claim 12 wherein the kibble comprises proteins selected from the group consisting of animal proteins including chicken, chicken liver, beef, beef liver, turkey, duck, buffalo, venison, lamb, pork, beef tripe, pheasant, Cornish game hens, trout, salmon, crab, lobster, crawfish, ocean white fish, tuna, shrimp, and walleye, and mixtures thereof.
